(19) United States
(12) Patent Application Publication
(10) Pub. No.: US 2013/0036355 A1
(43) Pub. Date: Feb. 7, 2013

(54) SYSTEM AND METHOD FOR EXTENDING VIDEO PLAYER FUNCTIONALITY

(71) Applicants: Bryan Barton, Sacramento, CA (US); Kevin Kalajan, Nevada City, CA (US)

(72) Inventors: Bryan Barton, Sacramento, CA (US); Kevin Kalajan, Nevada City, CA (US)

(21) Appl. No.: 13/566,549

(22) Filed: Aug. 3, 2012

Related U.S. Application Data
(60) Provisional application No. 61/514,902, filed on Aug. 4, 2011.

(51) Int. Cl. G06F 3/00

(52) U.S. Cl. 715/719

(57) ABSTRACT

A system and method for extending a video player for the purpose of embedded purchase, donation, and referral is described. An example embodiment includes: loading a video player into an application or web page, the video player having underlying video elements; using an application programming interface for the video player; creating an enhanced video player by creating various user interface elements layered on top of the underlying video elements to appear as if the created user interface elements are part of the video player; using the enhanced video player to play a video; and allowing a user/operator to donate, purchase, or provide information via the created user interface elements as a result of viewing the video or portion thereof.

### PRIORITY PATENT APPLICATION

This non-provisional patent application claims priority to U.S. provisional patent application Ser. No. 61/514,902; filed on Aug. 4, 2011 by the same applicant as the present patent application. This present patent application draws priority from the referenced provisional patent application. The entire disclosure of the referenced provisional patent application is considered part of the disclosure of the present application and is hereby incorporated by reference herein in its entirety.

### COPYRIGHT

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2012, Kevin E. Kalajan and Bryan Barton. All Rights Reserved.

### BACKGROUND

1. Technical Field

This disclosure relates to networked systems. Embodiments relate to the field of Internet-based video, network-based payment systems and Internet-based video applications and enhancements.

2. Related Art

Many websites and services have video players. YouTube.com is the most notable example of pre-rendered video files that are available for viewing by the Internet community at-large. Other companies such as Brightcove and Ooyala provide a white listed video player for publishers both large and small. These video players allow for basic functions such as “pause”, “play”, and “volume”. These video players also provide the ability to be embedded on other websites and to be easily shared through links and online social networks. These video players also provide analytics of varying detail. Sometimes these videos will allow the viewer to click on a link and send the viewer to another website during or after the video. Besides allowing users to post comments on the site where the video is hosted, there is very little interaction that a viewer can have with the video.

There are many software applications that can be used to enhanced online video. These software applications are predominantly used to download videos and to make sharing the videos easier. These applications can be initiated by consumers by installing applications on their browsers (such as the RealPlayer video downloader software); or they can be utilized by marketers who wish to enhance the impact of their video campaigns by allowing easier sharing, such as the “sharethis” embed plug in. However, these applications are of a “one size fits all variety” unable to be customized from one video to another.

U.S. Pat. No. 7,984,466 describes a method and apparatus for managing advertisements in a digital environment, including methods for selecting suitable advertising based on subscriber profiles, and substituting advertisements in a program stream with targeted advertisements. The Ad Management System (AMS) manages the sales and insertion of digital video advertisements in cable television, switched digital video, and streaming video (Internet) based environments. The AMS provides advertisers an ability to describe their advertisements (ads) in terms of target market demographics, required ad bandwidth, ad duration, and other ad specific parameters.

U.S. Pat. No. 8,095,682 describes how nodes in a realtime p2p media distribution can act in the role of ‘Amplifiers’ to increase the total available bandwidth in the network and thus to improve the quality of the realtime media consumed by the viewers. Examples of such media consumptions are TV channels over the Internet, video on demand films, and files, and media files downloaded to be consumed at a later time. Amplifiers are added to the p2p swarm by a mechanism that discovers the need for supplemental bandwidth in the swami and orders nodes to join the swami in the role of amplifiers. The amplifiers' main goal is to maximize the amount of bandwidth they supply (upload) to the swarm while minimizing the amount of bandwidth they consume (download).

U.S. Pat. No. 8,211,773 describes an apparatus and method for presenting zoom-able video via the Internet.

### BRIEF DESCRIPTION OF THE DRAWINGS

The various embodiments are illustrated by way of example, and not by way of limitation, in the figures of the accompanying drawings in which:

FIG. 1 illustrates users and various user agents that view video content;

FIG. 2 illustrates how a video player interacts with video content in an example embodiment;

FIG. 3 illustrates how the various user components are layered and communicate with information servers in an example embodiment;

FIG. 4 illustrates sample overlays in an example embodiment;

FIG. 5 illustrates a Buy overlay in an example embodiment;

FIG. 6 illustrates how the user agent communicates with the Statistics Database in an example embodiment;

FIG. 7 illustrates how an administrative user agent communicates with an Administrative Management Console and an information server in an example embodiment;

FIG. 8 demonstrates how the Client Processing Overlay (CPO) communicates with the Milestone Processing Server (MLS) in an example embodiment;

FIG. 9 is a processing flow diagram illustrating how to construct information for the video player based on an incoming Uniform Resource Locator (URL) or identifier (ID);

FIG. 10 is a processing flow diagram illustrating how to set up the CPO based on an iframe, script tag, or other method based on the meta data associated with the content;

FIG. 11 is a processing flow diagram illustrating how to initialize the Video Player (VP) based on a variety of common attributes;

FIG. 12 is a processing flow diagram illustrating how to show overlays and track events;

FIG. 13 is a processing flow diagram illustrating more of the flow of FIG. 12 (continuation);

FIG. 14 is a processing flow diagram illustrating what happens when a user chooses to close an overlay form;

FIG. 15 is a processing flow diagram illustrating sample validation, such as for a credit card; and

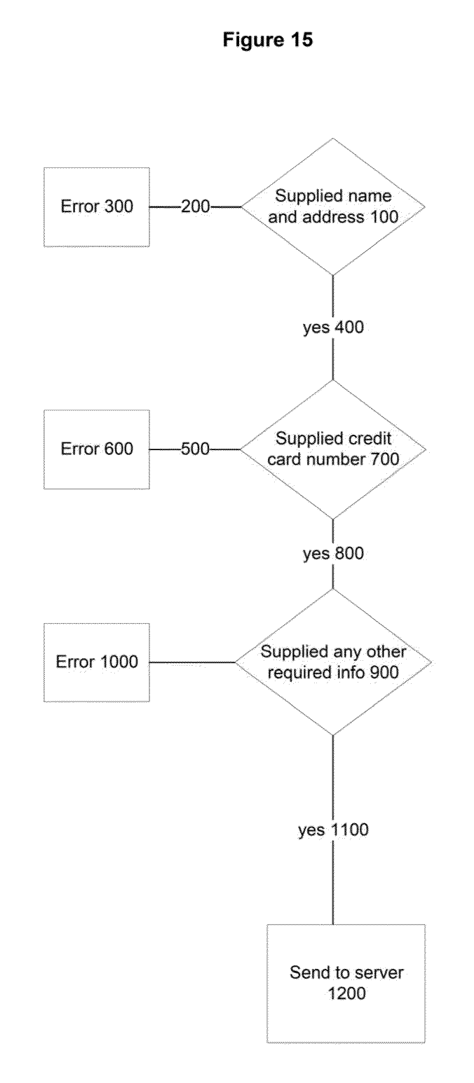

FIG. 16 shows a diagrammatic representation of machine in the example form of a computer system within which a set of instructions when executed may cause the machine to perform any one or more of the methodologies discussed herein.

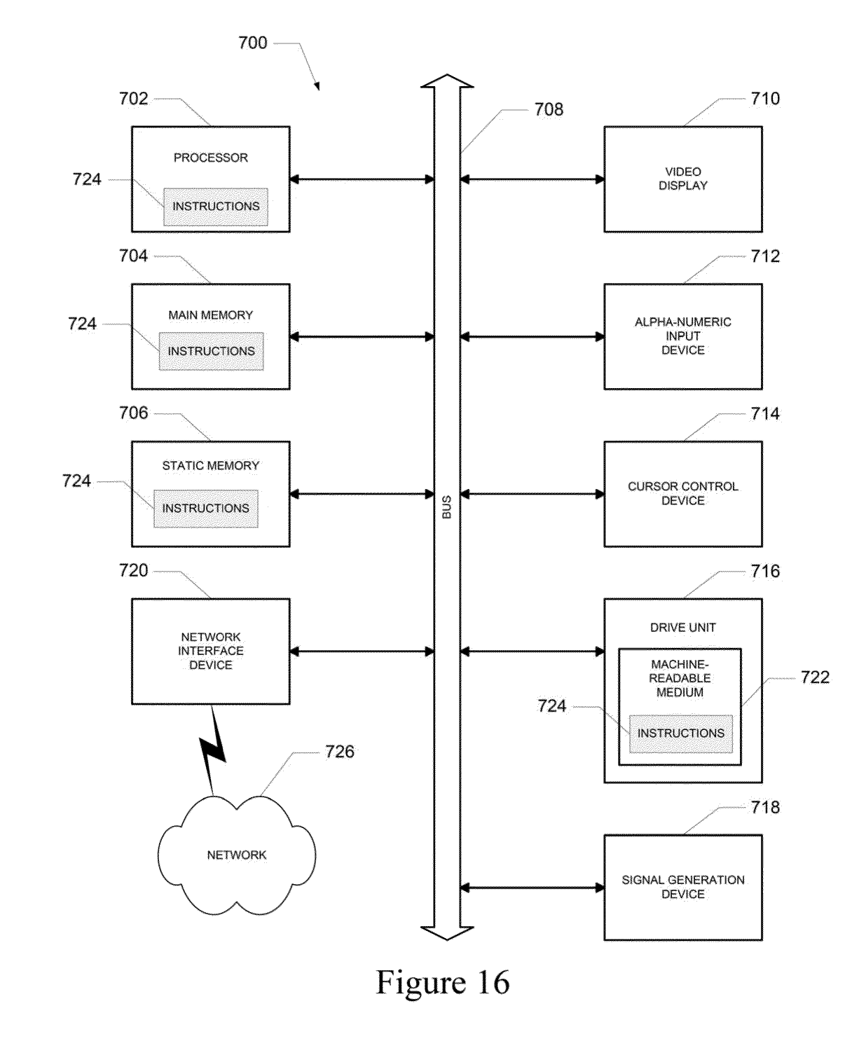

### DETAILED DESCRIPTION

A system and method for extending a video player and allowing secure transactions directly through an online video player is disclosed. In the following description, numerous specific details are set forth. However, it is understood that embodiments of the various embodiments may be practiced without these specific details. In other instances, well-known processes, structures and techniques have not been shown in detail in order not to obscure the understanding of this description.

As described herein, online video can emanate from any source (although currently flash and html 5 are by far the most popular) and be enhanced by our software to allow secure transactions. The embodiments of the invention pre-suppose that a video is available in many standard formats (e.g., flash, html 5, etc.) and the publisher of the video wants the viewer of the video to take one or more specific actions called “milestones” (e.g., secure capture of data, a survey, a credit card payment, etc.).

Although some of the conventional methods described in the Background section above deal with video enhancement, monetization of video, and have a dynamic process linking ads to the video, the various embodiments described herein are very different. Our invention has nothing to do with advertising being attached to the video, but rather making the video into an ad unit itself. Also, the conventional methods described above provide no way for the viewer to send secure information to the video provider.

Additionally, some of the conventional methods described above seek to improve the visual quality of the video being delivered by maximizing bandwidth. These techniques are very different from the various embodiments described herein. Our invention has nothing to do with the bandwidth or visual definition of the video being played, but is about the interaction which it provides. The conventional methods described above are not about the interaction between viewer and provider, but rather about increasing the quality of the delivered video.

The value of the embodiments of the invention is most noteworthy by allowing the process in which a credit card number (or other secure information) could be entered into the form within the video player. The video player may be hosted and viewed on a variety of platforms or web sites including a mobile device, an email, a blog or news web site, the website of the organization itself, placed as an ad unit or a social network. Regardless of the host location at which the credit card and user information is input, the data is processed over a Secure Sockets Layer (SSL) connection, although this is not required if confidentiality is not required. The data can then be passed to other software such as Customer Relationship Management (CRM) software. The credit card data is then sent to a credit card processor specified by the video producer. All of this can be done with the viewer never having to click through to another website.

For example, embodiments of the invention enable a seller of a widget to produce a video about “the wonders of his widget” and upload it to the internet as a flash file. The video is then enhanced by our software linking the video with the widget seller's credit card processor. The video is then spread around the internet and people are able to buy the widget from whatever site on which they happened to see the video, without ever having to open a new web page. Without the embodiments of the invention, there is no way to transmit secure information through the video player, forcing secure transactions to happen on another secure website.

The benefits of the various embodiments of the present invention include, without limitation, that a payment form (or other secure transaction form) associated with the video player is embeddable and sharable across the web, and that the payment form does not disrupt the user's viewing experience. Processing payments associated with video players typically require a user to navigate away from the video they are viewing or allow the video player to be disassociated from the payment mechanism. Organizations can leverage this information when they want viewers to take immediate action after watching a video. Hence, there are benefits to both the organization that produced the video and the viewer in facilitating a secure transaction to take place. There are several technical obstacles that must be overcome when creating a system to facilitate a secure transaction through a video player.

First, it is important to ensure that web browsers do not emit a “secure element within an insecure page” warning when the secure element (for credit card processing) is included in a non-secure page container.

Second, it is important to support multiple versions of a player overlay that automatically detects the type of user agent and loads an appropriate type of video player for that user agent (e.g. iPhone vs. Internet Explorer web browser).

Third, it is important to support multiple sizes and scaling for the placement of the overlayed components so they appear as the correct size and in the proper placement.

Fourth, it is important to track a myriad of user actions coupled with a timecode and to efficiently store this data in a remote server for subsequent tracking and analysis.

Fifth, it is important to support realtime analysis of user behavior to pro-actively update the overlayed elements to increase the probability of reaching a desired milestone.

Various embodiments of the present invention are possible based on the disclosure provided herein. A few of these embodiments are listed and described below.

First, an embodiment of the invention allows a video producer to sell a tangible product through the video.

Second, an embodiment of the invention allows a donation to a political campaign or nonprofit after watching or during the playing of a video.

Third, an embodiment of the invention allows a video to securely capture leads and survey question data after or during a video.

The implementation details of an example embodiment are now provided below.

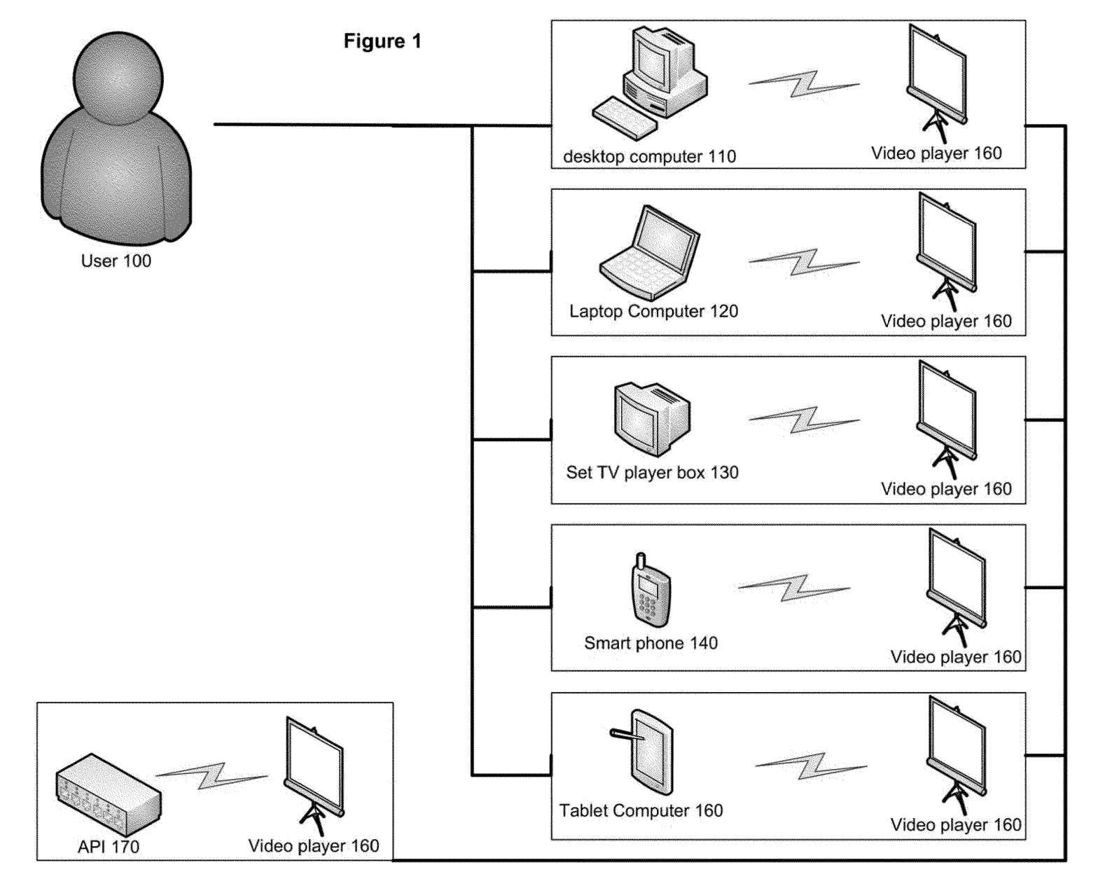

Referring now to FIG. 1, the end user (“EU”, see component 100 in FIG. 1) represents a human viewing a video via an embodiment of the invention. The software of that runs on the end user's computer system (mobile phone, tablet, set top box, laptop computer, desktop computer, etc., (see components 110-150 in FIG. 1) that displays the video content is called the Video Player (“VP”), see component 160 in FIG. 1). The Video Player can be existing commercially available software (including public domain/open source) that is responsible for playing video content from a variety of sources. Some examples of video players include: the YouTube video player, jwplayer, flowplayer, Adobe flash, Microsoft Windows Media Player plugin, Microsoft Silverlight, Apple Quicktime, Realplayer, Vimeo Player, HTML5 video players that are part of all contemporary Internet web browsers. Any video player technology that offers an application programming interface (“API”, see component 170 in FIG. 1), published or otherwise reverse-engineered, represents a video player that the embodiments of the invention can extend for the purpose of the description herein. Note that many VPs are possibly built on top of other VP technology (e.g. the YouTube Player (non HTML 5 version) is built on top of the Adobe Flash Video Player technology.

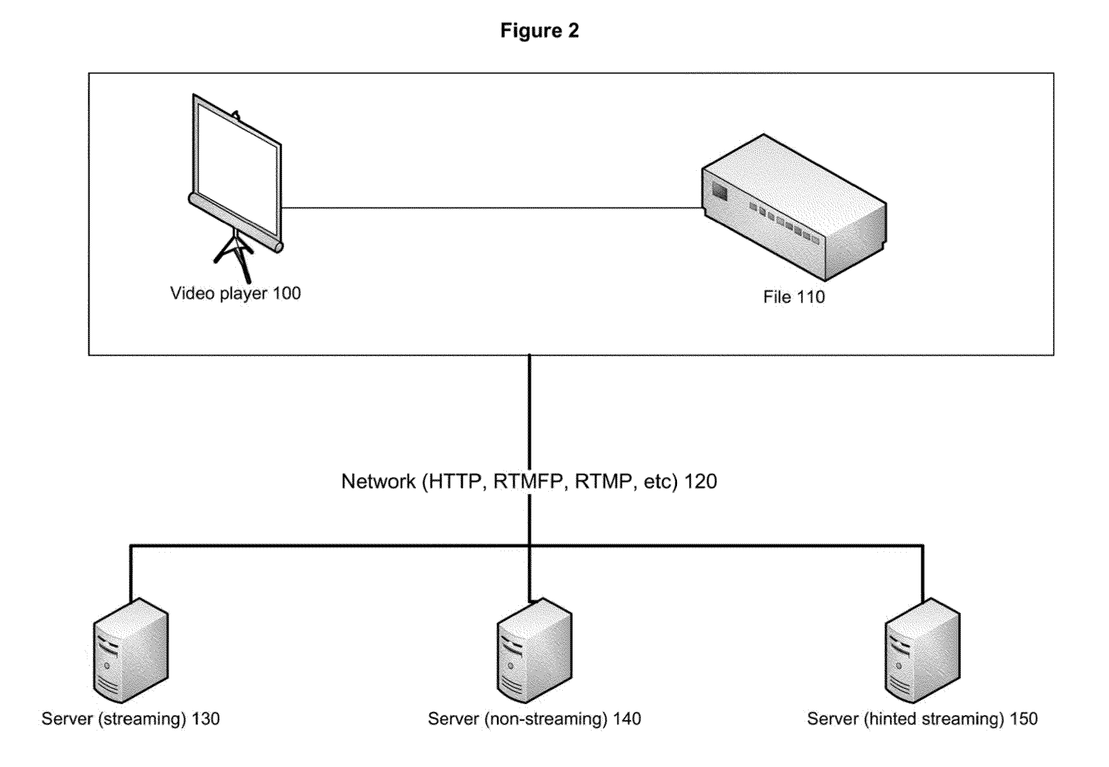

The video content that is played by the VP can be any pre-recorded or live content, and can come from traditional streaming servers using streaming protocols (e.g. RTMP, RTSP, RTMFP, etc. see component 130 in FIG. 2), local video files on the user's computer system (component 110 in FIG. 1), hinted streaming protocols (e.g. “hinted Quicktime streaming”, component 150 in FIG. 2), simulated streaming via HTTP requests that buffer content (component 140 in FIG. 2), or “load and play” technologies where the entire video file is downloaded from a remote server via a Uniform Resource Locator (URL) and when the video content is completed downloaded it begins playing within the VP (component 140 in FIG. 2). The example embodiment is not limited to the above techniques, and, in fact, how the video content is loaded into the player is in no way tied to the example embodiment.

Use of an embodiment of the invention begins by a user going to a web URL (or accessing the desired video content via an appropriate mechanism, such as clicking on an option on a TV set top box). The following discussion describes processing of the web URL, but can easily be applied to a set top box or other user interaction devices. Note: the URL can be accessed by any device form factor such as a mobile phone, tablet, laptop, traditional computer, computer-embedded kiosk, etc.

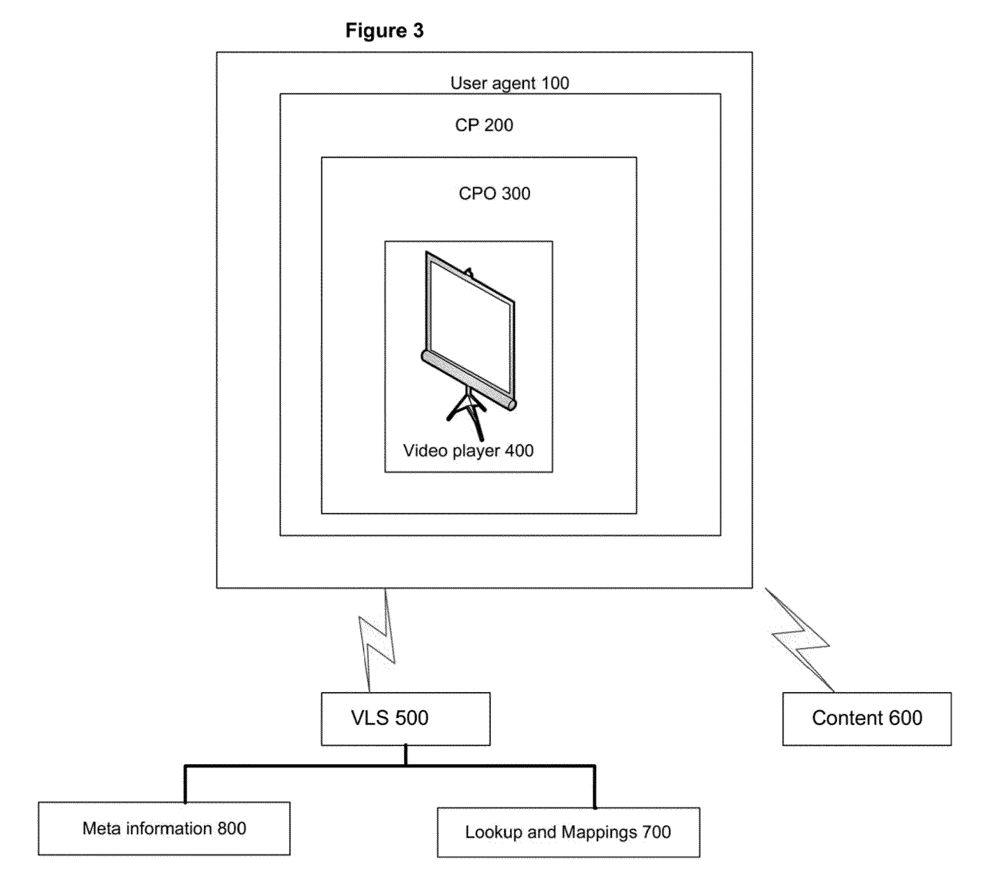

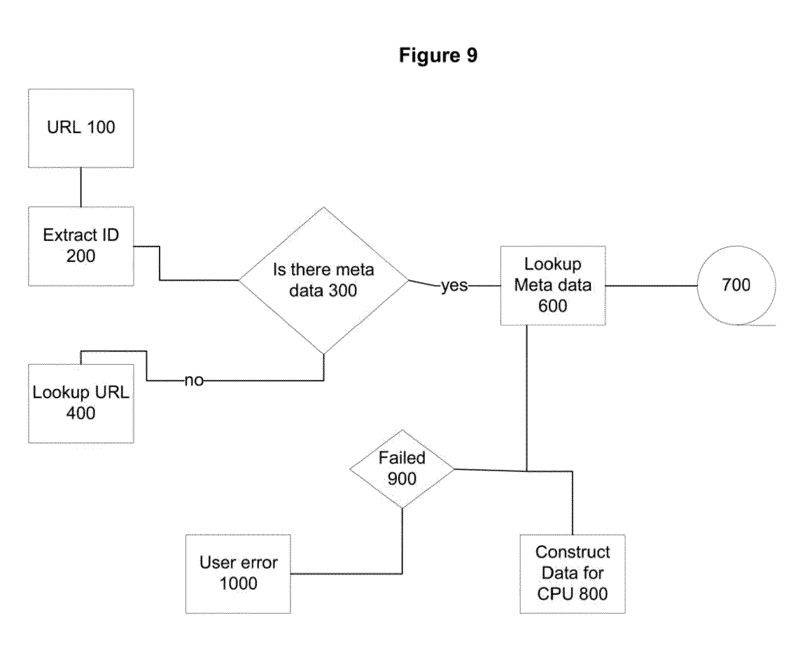

The web URL causes the browser to make a request to a server that implements the example embodiment's Video Loading Subsystem (VLS, component 500 in FIG. 3). The purpose of the VLS is multi-faceted. First, the URL that is provided may contain various pieces of information, one of them being some indicator as to the video or stream that is desired to be viewed/loaded into the VP. The actual source of the video to be loaded could be provided within the URL (encoded) but normally this would not be done. Instead, the example embodiment would receive an identifier (“ID”) within the request URL that is then mapped (looked up in a database) to determine the underlying source and meta-information about the desired video content. For example, the URL may be something like, “http://donortube.com/watchvideo/12345”. The URL does not have to use the HTTP protocol (it could be “https” or other variants). The VLS takes the ID (e.g. “12345”) and looks up in a database, a lookup table, a mapping array, or any other method to correlate an ID to a known source for video content (see component 700 in FIG. 3). In this case, the ID “12345” may be correlated to a video at some content server source (see component 600 in FIG. 3), for example at YouTube.com, with YouTube ID “abcde”. The underlying mapping of the example embodiment may correlate the ID to a specific video URL, or it may store meta information that is subsequently used to instantiate the VP with the correct information. For example, storing the URL for an ID might map “12345” to “http://www.youtube.com/watch?v=abcde” whereas storing the meta information may store (in a database or other form of persistent storage, or inline code array) the meta information: “source”=“youtube.com”, “id”=“12345”. The basic difference between the two approaches is that in one case a single reference to a URL (or equivalent) is stored, and in the other case an arbitrary set of meta information (see component 800 in FIG. 3) is stored that is subsequently used by the VLS to provide the required information to the relevant player API. See processing steps 100-800 in FIG. 9.

If no entry for the ID was found, an error is reported to the user. See processing steps 900-1000 in FIG. 9.

Once an entry is found for the ID, the information (or URL) is looked-up for the ID and information obtained (see processing step 600 in FIG. 9). The meta information (component 800 in FIG. 3) may include information about the video itself including source ID (e.g. for a service such as YouTube or Vimeo), duration, title, container format, encoding format, formats available (e.g. HD. mobile, etc), type (retail product trailer, non-profit organization video, political campaign, etc.), autoplay (or not), initial size, payment options, legal restrictions, etc. There is no limit to the amount of meta information stored and the information stored may vary based on the type of content and purpose of the video content (e.g., e-commerce, vs. non-profit, vs. political, etc.). The meta information is used in a variety of ways (later discussed), but initially the information is used to instantiate the video player with its corresponding API so that the user views the video or a still frame when the web page loads that accesses the containing page.

The containing page (“CP”, see component 200 in FIG. 3) is the web page or user element container that contains the video player. This may or may not be the same underlying web domain name from which the VLS is running from. For example, a user might go to “bobjonesforpresident.com” and an element on the page (e.g. “iframe”) subsequently references the VLS at “http://www.donortube.com/12345”.

It is important to note that the VLS can be accessed via the “SRC” attribute of an HTML iframe, the SRC attribute of an “embed” tag, or the SRC attribute of an HTML “script” tag, or any other existing or future mechanism that allows an Internet web page to embed content and elements originating from another domain name. In the case of the URL used for instantiation, various parameters can be supplied to give the VLS some additional information. For example, the desired size, autoplay (or not), and other ancillary information can be provided that may (or may not) override what meta information is already known by the VLS about the video object.

One novel embodiment is to use the “script” tag to avoid web browser warnings where the source containing page is not a secure page (e.g. https:// . . . ) but the “src” to the VLS is an HTTP/S (secure) connection for the purposes of encrypting the communication between the end-user and the VLS where credit cards may be sent and processed. By using the “script” tag, via such a technology as “JSONP” (“JSON with Padding”, “JSON” is “Javascript Object Notation”) or CORS (“Cross Origin Resource Sharing”) the browser warnings can be avoided.

In the case of invocation via a “script” tag, the VLS is responsible for emitting the appropriate javascript (or other relevant script language such as ECMAscript, ActionScript. Java Applet, etc) so that the video player is properly instantiated on the page, in the correct place, with the correct size and other attributes (e.g. background color).

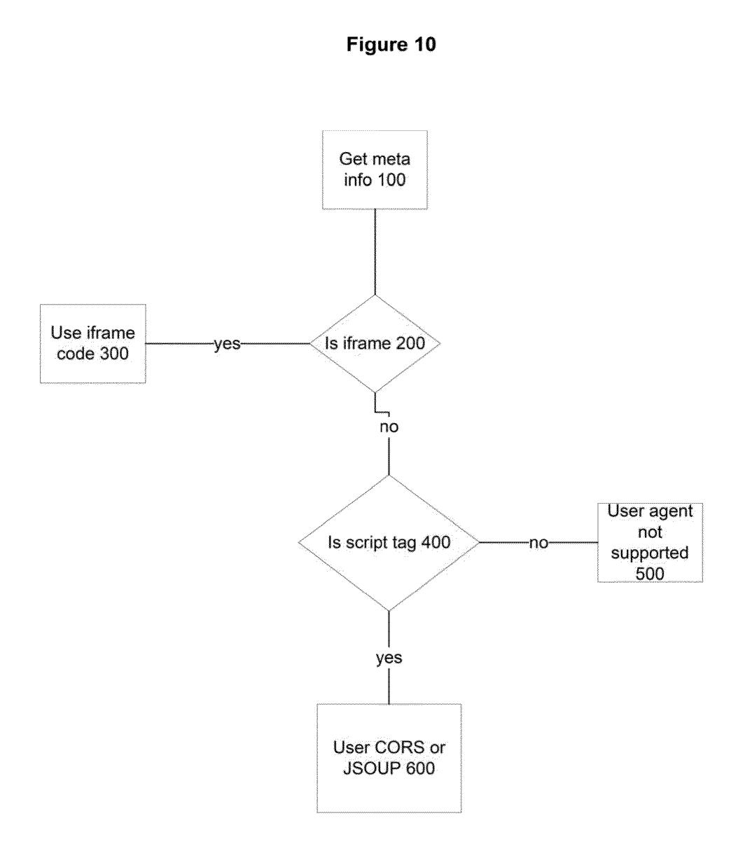

Once the VLS determines if it is in iframe mode, script tag mode, or something else (see processing steps 100-600 in FIG. 10) it executes the appropriate program logic to emit the relevant HTML (or other page layout language instructions) such that the appropriate video player is invoked via the browser (or user agent) with the relevant video and appropriate options. This is called the Client Processing Overlay (CPO), see component 300 in FIG. 3). The Client Processing Overlay is what extends the functionality of the VP in a seamless way and enables an integrated user experience.

For example, the VLS may determine that the browser page is an “old” browser and HTML5 with embedded player technology is not supported and in that case an Adobe Flash-based video player is loaded (e.g. the YouTube player, jwplayer, flowplayer, vimeo player, etc). Each of these video players has their own APIs (application programming interfaces) which are used to control their operation. It is via these APIs that the example embodiment extends the capability and transparently enables embedded payment, purchase, donation, etc. transparently to the user/operator.

In the case of HTML 5, a separate player is not loaded or referenced, but instead the Javascript-based access methods to standards-compliant browsers are used versus a proprietary or player-specific API (e.g. YouTube embedded player). The VLS is still required to emit the appropriate Javascript and HTML such that example embodiment works as described below.

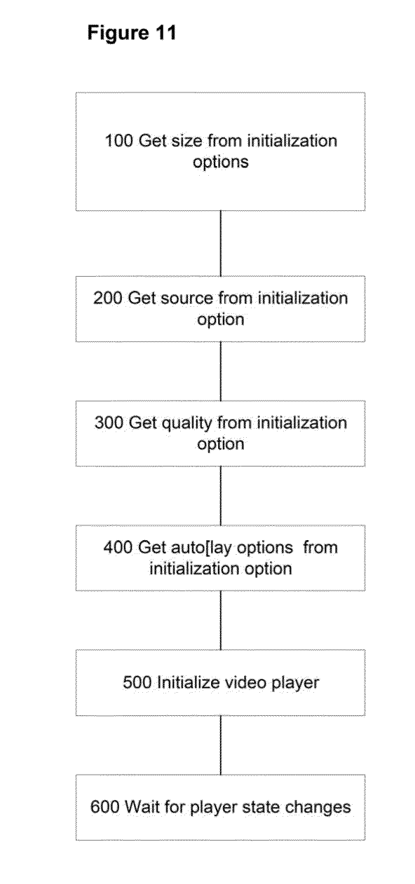

When the VP is loaded (HTML 5, proprietary, or other) via the logic from the VLS, it is set to load with a given size, source video content (URL or ID), quality (HD or other), autoplay (or not), among other possible options (see processing steps 100-500 in FIG. 11). After loading, the CPO waits for various events from the VP or the user-agent so it can perform various actions described below (see processing step 600 in FIG. 11).

The CPO is typically Javascript or similar scripting language that uses an Application Program Interface exposed via the VP. Note that the API may be public and formalized, or obscured and reverse-engineered yet still available. See component 170 in FIG. 1.

When the CPO runs within the User Agent (browser, mobile device, set top box, etc.) (see component 100 in FIG. 3) it performs a series of steps. The first step is to create the VP instance as described above.

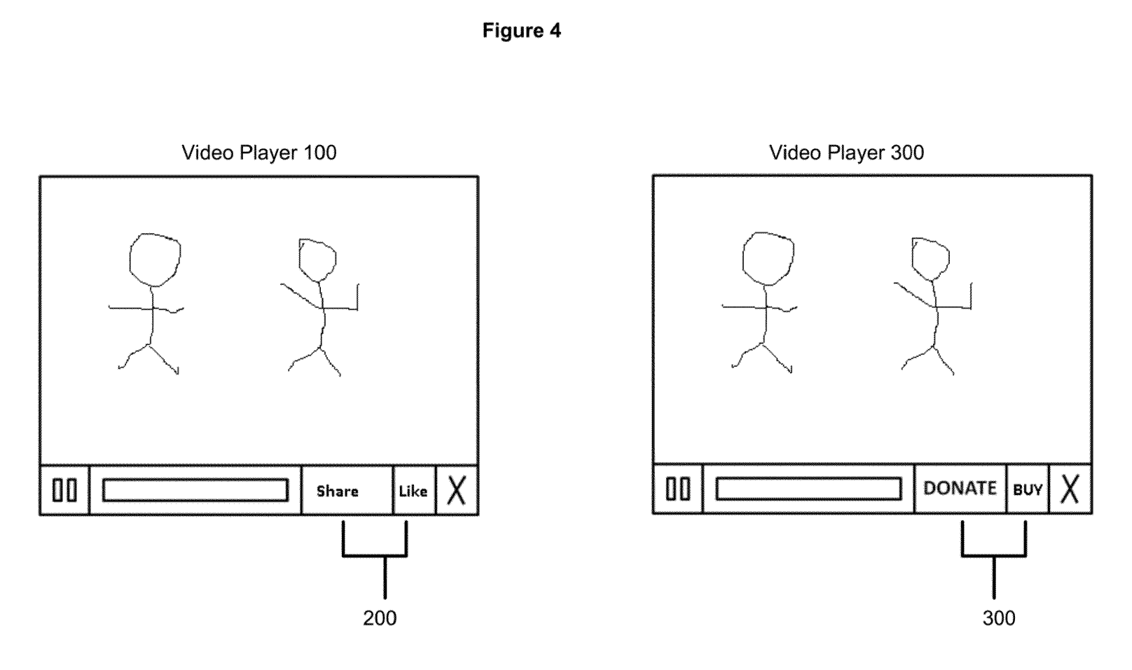

The second step is to create overlays (transparent masks) over the VP such that user perceives the elements are actually part of the VP. In one embodiment, this is done by creating HTML elements on top of other HTML elements (or Flash or Silverlight objects) with a higher z-index (3D depth) than the underlying element. For example, if a “Donate” tab, a “Buy” tab, or a “Share” tab is desired to appear within the embedded VP, then transparent graphics or HTML element can be placed over the VP in specific positions, with transparent backgrounds, to make it appear to the user that the clickable elements are actually part of the VP (see components 200 in FIG. 4). Hover states are also supported such that they light-up or manifest a different appearance when the user “rolls over” or “mouses over” various components added at a higher z-index.

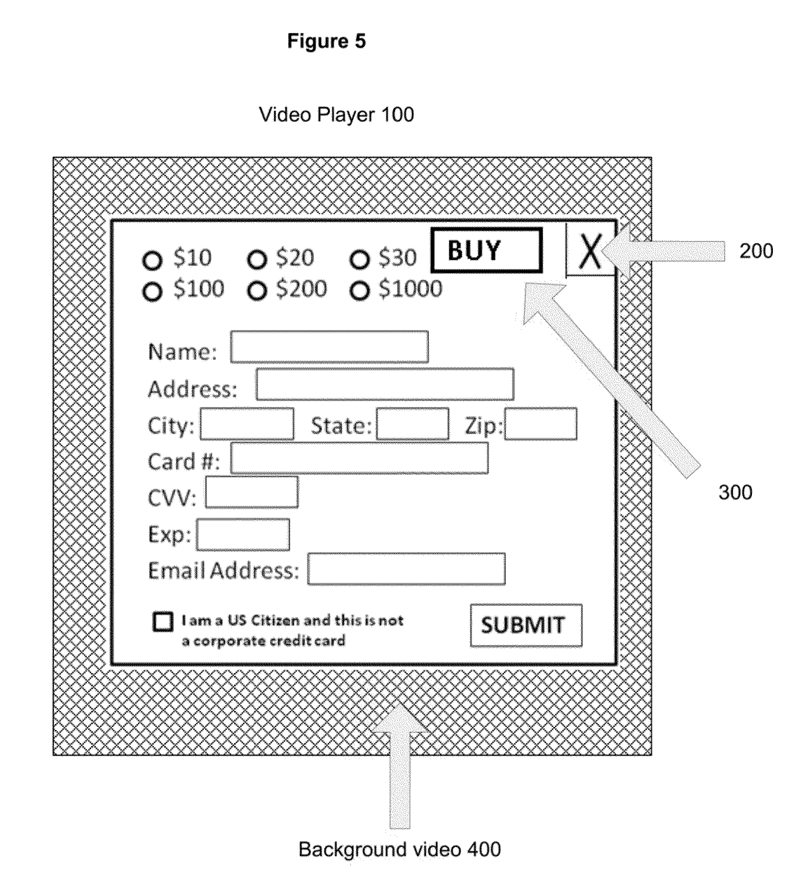

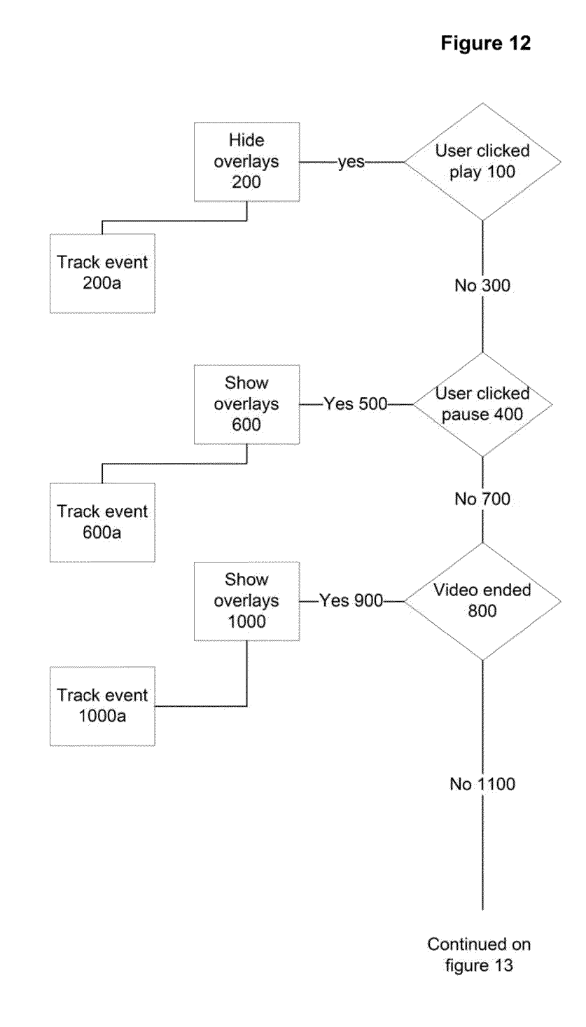

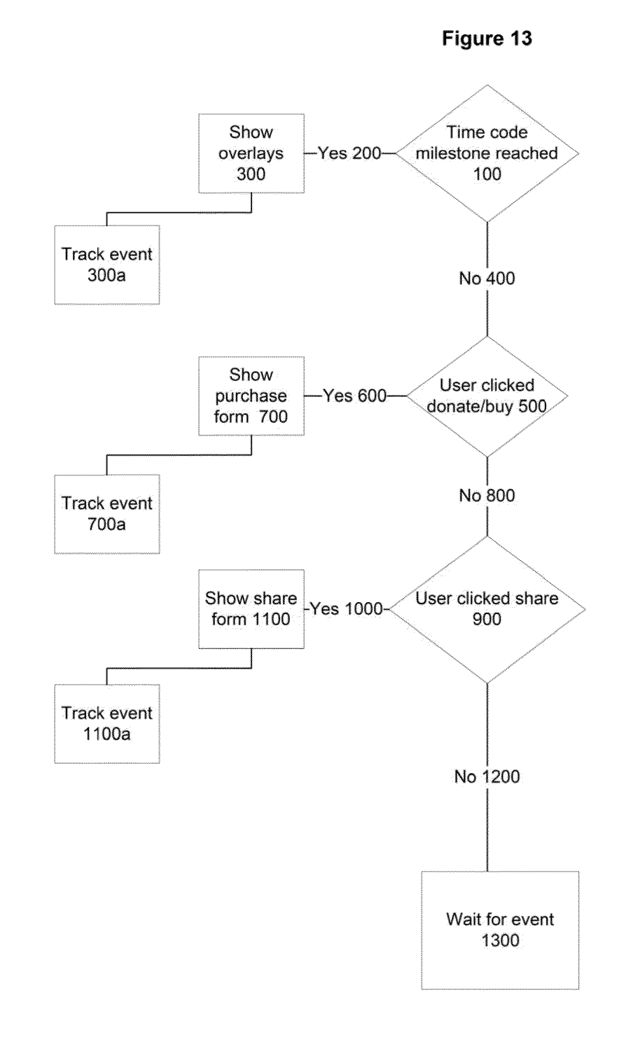

Once various elements are added by the CPO, additional logic within the CPO interacts with the VP in real-time (see steps 100-1100 in FIG. 12 and steps 100-1300 in FIG. 13). If the video is playing and the user pauses the video via a control in the VP or an element added by the CPO, then the CPO may cause another layer or element to appear that overlays on top of (or adjacent to) the video content. For example, in one embodiment, if the video is playing and the user causes the video to pause, the CPO may be display content relevant to “buy this item now” or “donate to this political campaign” or “donate to this charity” (or other similar options based on the underlying video content, e.g. “buy a ticket to see the band/show”, etc.). The underlying video content may or may not be translucent (visible) based on the opacity set in the element that overlays on top of the video content (see component 400 in FIG. 5).

If the user moves forward with the purchase, donation, etc. (whatever action is the objective) a subsequent confirmation screen is provided to the user. This confirmation may contain web hyperlinks or other related information.

Other overlay options may appear at various times based on various criteria. In one embodiment, a user may see the Facebook “like” or “share” button appear, including other social network sites (LinkedIn and Twitter) or other context-specific options. Various factors may contribute to the dynamic overlay content (provided by the CPO) appearing or not appearing, such as, but not limited to various factors: play/pause state, duration of time watching video, duration of time watching but not clicking or moving the mouse, duration of time watching and moving the mouse to various positions, clicking on elements that appear (such as BUY or DONATE (see components 300 in FIG. 4 and component 300 in FIG. 5)), specific timecode positions of the video (e.g. at 10 seconds into the video there is call-to-action and a button is enabled).

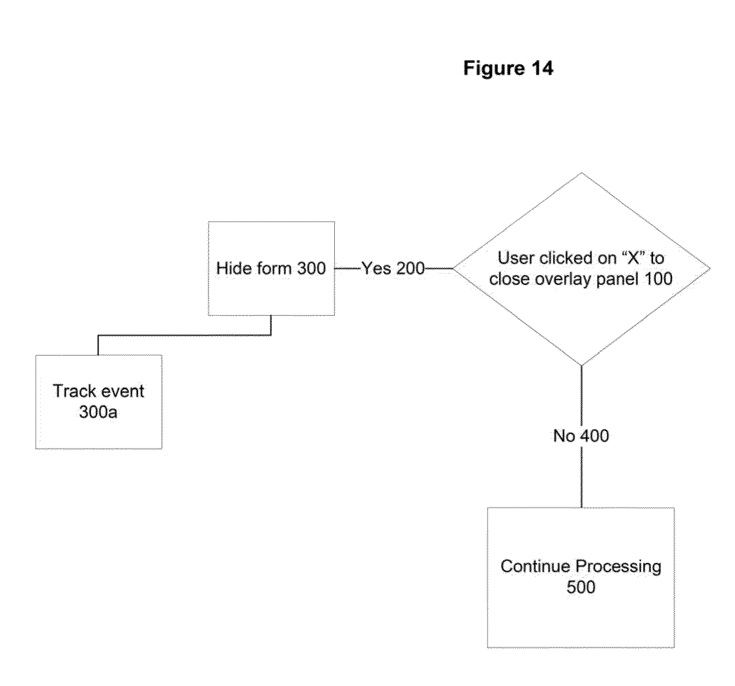

The CPO may provide an “X” (see component 200 in FIG. 5) element or some user interface element to close or hide many elements and resume watching the video, or simply dispose of the unnecessary items for readability improvement (see processing steps 100-500 in FIG. 14).

In one embodiment, statistics and analytics tracking is done by the CPO (see processing steps 200A, 600A, 1000A on FIG. 12, processing steps 300A, 700A, 1100A in FIG. 13, and processing step 300A in FIG. 14). Various elements of the user may be kept by sending the information from the CPO to a web server (or any system connected via a network for which the CPO can transmit such information) or the information may be tracked locally and uploaded/analyzed to a third server at a later date. Such information may include Internet Protocol (IP) address, browser, user agent, timecode of video, video ID being watched, time of play, time of pause, time of resume/play, user agent timezone (timezone of the user), plugins installed within the browser, model of phone, tablet, set top box, duration of time spent on containing page, among many other possible statistics that can be gather about the viewer and viewer's physical environment (including latitude, longitude, default language, among other things).

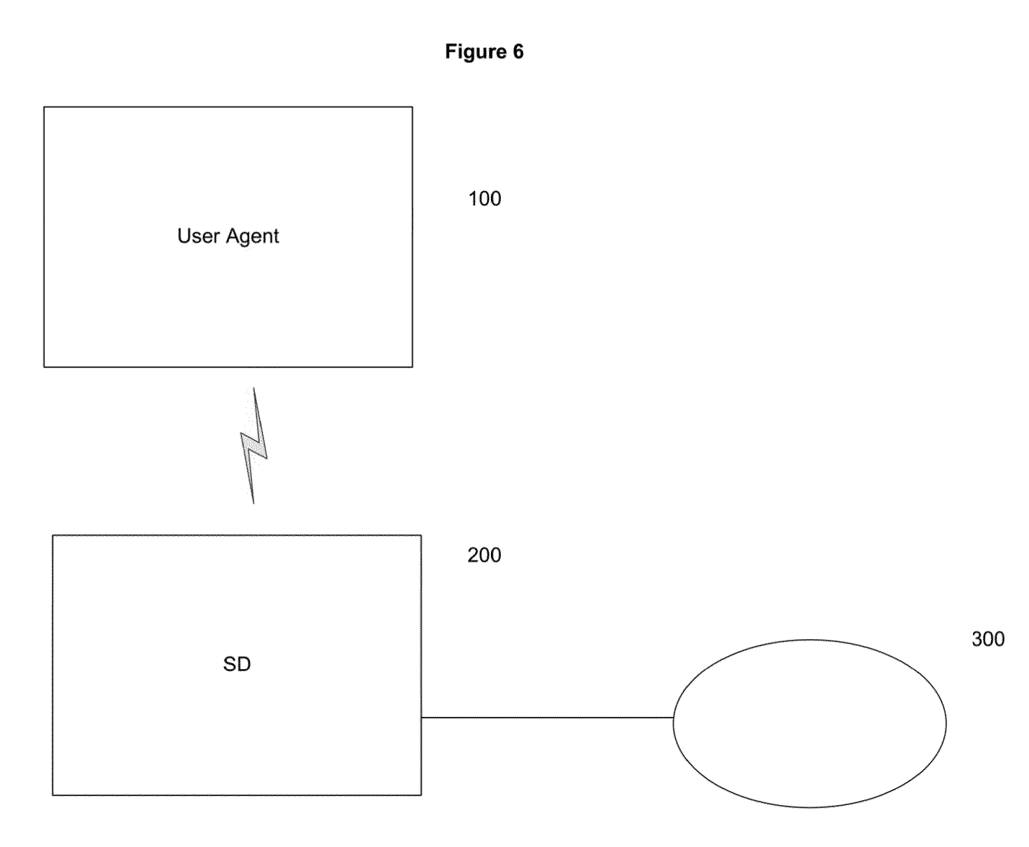

Software on the system where such statistics are uploaded, called the Statistics Database (SD) (or where the software can access such a repository of information) may be used to report on amounts donated, popular video IDs, average duration watched, typical time when donations or purchases are made, among many other similar analytics used for reporting and statistics and data mining purposes (see components 200-300 in FIG. 6).

In yet another embodiment, a button or link or user element that enables the sharing of the underlying content may be provided so as to increase the number of users/people possibly viewing the underlying content with the example embodiment. See processing step 1100 in FIG. 13, and components 200 in FIG. 4. For example, the Facebook SHARE button may be made visible after the user has purchased or donated. When the user clicks SHARE, the underlying software that is executed by Facebook (or Twitter, or LinkedIn, or any other analogous sharing implementation) gathers information about the video content by using information provided in the button setup by the CPO or by elements on the page supplied by the VLS. Often this consists of placing “META” tags within the page or document in which the VP resides such that the destination sharing system can gather information about the content and provide an appropriate link and or thumbnail of the content when the shared content is made visible in the target environment (e.g. “Facebook wall”). In many cases this might require different VP's for different environments. The VLS can detect the source of the request and load the appropriate VP based on the requestor and request type (e.g. using a Flash-based VP vs. HTML 5 in the case of a Facebook viewing request).

Additional sharing options may not be social networking-specific, but instead be generic such as HTML provided to the user to “embed this video” on another website (which could be an “embed” tag, an “iframe tag”, a “script tag” or many other existing and future mechanisms to embed software elements on a web page or set top box or other user agent environment). As well, a simple “link” to the video can be provided as it is very generic in nature and can be used in any environment. Other types of links and references can be provided depending on the existing and future linking options.

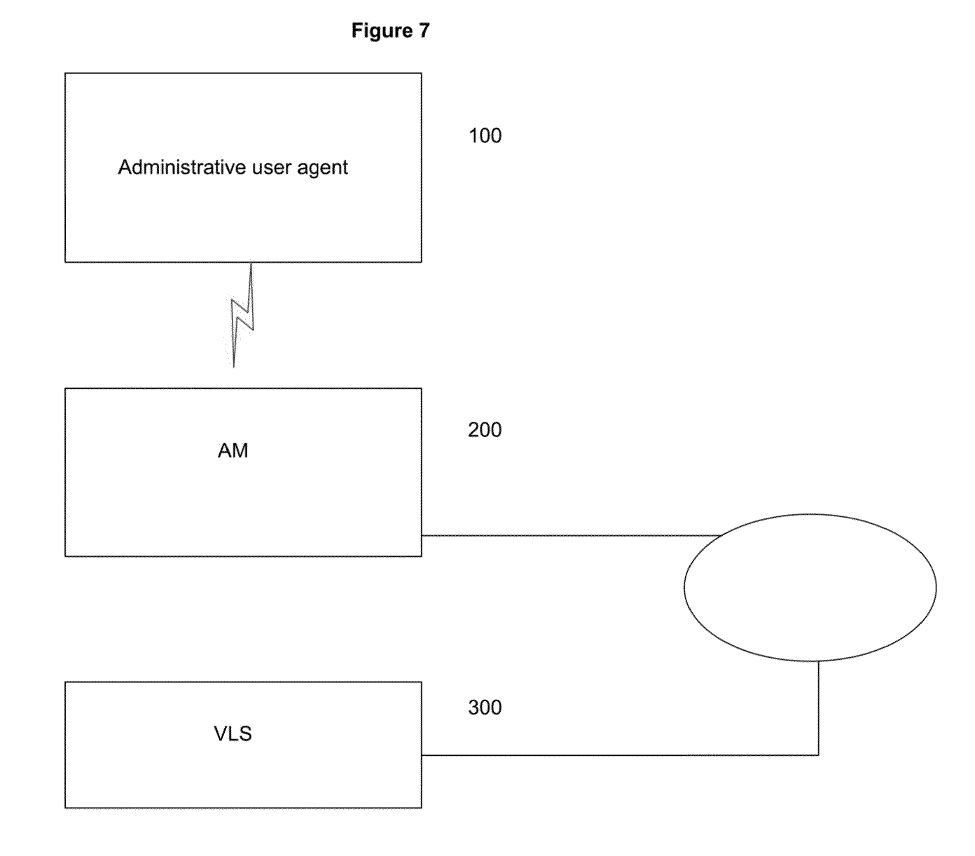

In yet another embodiment, an Administration Module (“AM”, see component 200 in FIG. 7) may provide the back-end administration of videos, customers, payment mechanisms, reports, etc. It may provide the listing of videos in the system, for each customer or partner or content creator, a preview of each video as seen by the target user, the “embed” code to place the VP and CPO on the appropriate containing page, a TEST link, an EDIT options feature, a DELETE video option, a display of total number of plays/views, amount of money raised or amount purchased, among many other types of statistics. Note that the VLS may also share the same database to determine how to render the CPO as previously described (see component 300 in FIG. 7).

The AM may also maintain meta information about the organization associated with a given video, such as organization name, website URL, email list of users who get notified based on various events (amount of money raised, number of views milestone, etc.), configuration options for donation amounts, purchase prices, model numbers, colors, part numbers, links for more information or training videos, payment options with relevant account data (e.g. PayPal account information, merchant IDs, etc.), maximum amounts to be accepted (e.g. for donations), any disclaimer text, notes warnings, regional variances or restrictions, languages available, location of alternative language modules or text, are just some examples. This information is used by the CPO to control and display the interaction with the end-user.

Ultimately, the objective of the CPO is to get the end-user to a milestone. The milestone may be donating to a political campaign, donating to a non-profit organization/cause, purchasing a product, entering information for referrals (e.g. “participate in the raffle”), lead generation data (email address, name, address, phone number, etc.), or other similar information.

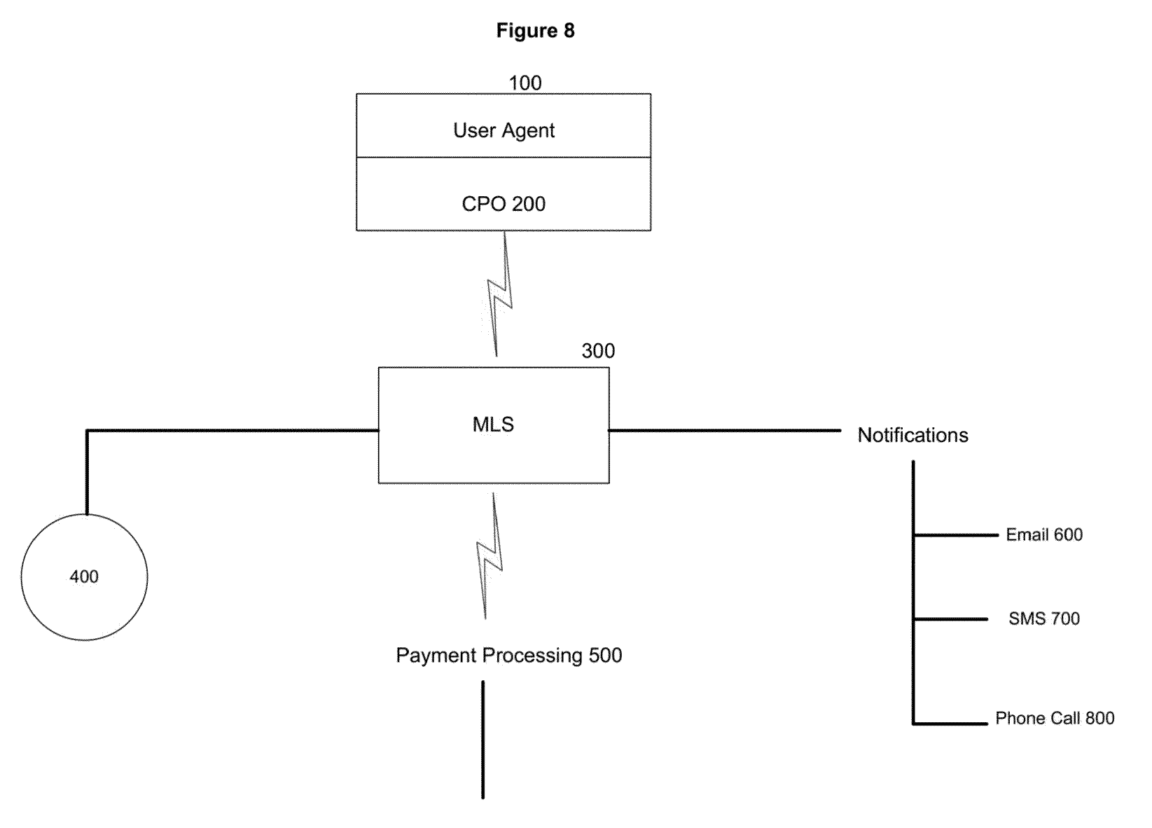

In one embodiment, when the user clicks on a user interface element that causes them to reach the milestone (e.g. “DONATE NOW”), a “form” is provided them to enter appropriate and relevant information (see component 300 in FIG. 5). When they enter the information, validation is performed within the CPO (see processing steps 100-1200 in flowchart 15) and if all the data is valid, the information is sent to a network-based server to which the CPO has access. This is typically the VLS but does not have to be. This server is called the Milestone Processing Server (MLS) and is responsible for processing the user's request and storing whatever relevant information (see FIG. 300 in FIG. 8). For example, if the user enters credit card information, name, address, phone number, etc., the CPO sends this information to the MLS where the transaction is either completed successfully (or not). Appropriate information is provided to the user (e.g. “Thanks for your donation”, “Credit card number is invalid”) and appropriate logs are created on the MLS for each request and transaction. The communications between the CPO and the MLS may or may not be encrypted/secure depending on various requirements.

The MLS stores transactions in a local repository (see component 400 in FIG. 8) and may either process credit card transactions locally or using 3^{rd} party services (see component 500 in FIG. 8). The MLS may also send email, SMS, phone call, or other types of notifications based on a variety of criteria (thresholds being met, low volume, high volume, etc.) (see components 600-800 in FIG. 8).

The software of the example embodiments described herein can be partitioned into a set of modules or components. Each of these modules can be implemented as software components executing within an executable environment of the video processing system operating on a computing platform. Each of these modules of an example embodiment is described in detail above in connection with the figures provided herein.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

We claim:

1. A method comprising:
loading a video player into an application or web page, the video player having underlying video elements;
using an application programming interface for the video player;
creating an enhanced video player by creating various user interface elements layered on top of the underlying video elements to appear as if the created user interface elements are part of the video player;
using the enhanced video player to play a video; and
allowing a user/operator to donate, purchase, or provide information via the created user interface elements as a result of viewing the video or portion thereof.

2. The method as claimed in claim 1 including enabling sharing and linking of the enhanced video player.

3. The method as claimed in claim 1 where the enhanced video player does not generate web browser warnings about secure content loaded in an insecure page.

4. The method as claimed in claim 1 including allowing configuration and control of a plurality of videos including meta information about the plurality of videos and relevant organizations or entities associated with the content of the plurality of videos.

5. The method as claimed in claim 1 wherein the enhanced video player includes a “Donate” tab layered on top of the underlying video elements enabling the user/operator to perform a donation transaction via the enhanced video player.

6. The method as claimed in claim 1 wherein the enhanced video player includes a “Buy” tab layered on top of the underlying video elements enabling the user/operator to perform a purchase transaction via the enhanced video player.

7. The method as claimed in claim 1 wherein the enhanced video player includes a button corresponding to another social network site layered on top of the underlying video elements enabling the user/operator to access a feature of the corresponding social network site.

8. A system comprising:
a data processor;
a network connection, in data communication with the processor, for access to a network; and
a video processing system module, executable by the processor, to:
load a video player into an application or web page, the video player having underlying video elements;
use an application programming interface for the video player;
create an enhanced video player by creating various user interface elements layered on top of the underlying video elements to appear as if the created user interface elements are part of the video player;
use the enhanced video player to play a video; and
allow a user/operator to donate, purchase, or provide information via the created user interface elements as a result of viewing the video or portion thereof.

9. The system as claimed in claim 8 being further configured to enable sharing and linking of the enhanced video player.

10. The system as claimed in claim 8 where the enhanced video player does not generate web browser warnings about secure content loaded in an insecure page.

11. The system as claimed in claim 8 being further configured to allow configuration and control of a plurality of videos including meta information about the plurality of videos and relevant organizations or entities associated with the content of the plurality of videos.

12. The system as claimed in claim 8 wherein the enhanced video player includes a “Donate” tab layered on top of the underlying video elements enabling the user/operator to perform a donation transaction via the enhanced video player.

13. The system as claimed in claim 8 wherein the enhanced video player includes a “Buy” tab layered on top of the underlying video elements enabling the user/operator to perform a purchase transaction via the enhanced video player.

14. The system as claimed in claim 8 wherein the enhanced video player includes a button corresponding to another social network site layered on top of the underlying video elements enabling the user/operator to access a feature of the corresponding social network site.

15. A non-transitory machine-useable storage medium embodying instructions which, when executed by a machine, cause the machine to:
load a video player into an application or web page, the video player having underlying video elements;
use an application programming interface for the video player;
create an enhanced video player by creating various user interface elements layered on top of the underlying video elements to appear as if the created user interface elements are part of the video player;
use the enhanced video player to play a video; and
allow a user/operator to donate, purchase, or provide information via the created user interface elements as a result of viewing the video or portion thereof.

16. The machine-useable storage medium as claimed in claim 15 being further configured to enable sharing and linking of the enhanced video player.

17. The machine-useable storage medium as claimed in claim 15 where the enhanced video player does not generate web browser warnings about secure content loaded in an insecure page.

18. The machine-useable storage medium as claimed in claim 15 being further configured to allow configuration and control of a plurality of videos including meta information about the plurality of videos and relevant organizations or entities associated with the content of the plurality of videos.

19. The machine-useable storage medium as claimed in claim 15 wherein the enhanced video player includes a “Donate” tab layered on top of the underlying video elements enabling the user/operator to perform a donation transaction via the enhanced video player.

20. The machine-useable storage medium as claimed in claim 15 wherein the enhanced video player includes a “Buy” tab layered on top of the underlying video elements enabling the user/operator to perform a purchase transaction via the enhanced video player.
